(19) United States
(12) Patent Application Publication
(10) Pub. No.: US 2024/0354719 A1
(43) Pub. Date: Oct. 24, 2024

(54) SYSTEMS AND METHODS FOR SMART ROUTING OF ELECTRONIC MESSAGES

(71) Applicant: Wells Fargo Bank, N.A., San Francisco, CA (US)

(72) Inventors: Lance P. Dumond, Santa Cruz, CA (US); Ravi Viswanath Mangipudi, Cincinnati, OH (US); Swapna Movva, Plymouth, MN (US); Jason Wah Lone Chiu, San Jose, CA (US); Jeremy Craig Rose, Gresham, OR (US); John T. McCue, Jr., Dresher, PA (US); Dorothy T. Burleson, Sewell, NJ (US); Tri Duc Tran, Charlotte, NC (US)

(21) Appl. No.: 18/303,046

(22) Filed: Apr. 19, 2023

(51) Int. Cl. G06Q 20/02; G06Q 20/10

(52) U.S. Cl. CPC G06Q 20/023; G06Q 20/108

(57) ABSTRACT

Systems, apparatuses, methods, and computer program products are disclosed for performing smart routing of electronic payment requests. An example method includes: obtaining an electronic payment request; determining that the electronic payment request is associated with a pre-selected payment type; and processing, in response to the determination, the electronic payment request as an electronic payment having a first payment type different from the pre-selected payment type.

### BACKGROUND

Computing devices may provide various services such as electronic payments. Computing devices may also be trained to automatically provide such services without human intervention.

### BRIEF SUMMARY

Automated Clearing House (ACH) and wire transfers (namely, international wire transfers utilizing the Society for Worldwide Interbank Financial Telecommunications (SWIFT) platform, MT103/MT102/pacs.008 messages, or the like) are both methods of electronically transferring funds between bank accounts. However, there are several reasons why ACH can be considered better than wire transfers such as: (1) ACH transfers are typically cheaper than wire transfers where wire transfers often involve higher fees, especially for international transfers; and (2) ACH transfers are more convenient as ACH transfers can be set up and initiated online and can be automated for recurring payments. Additionally, because of the high cost of wire transfers, international entities (or international subsidiaries of domestic entities) that frequently wire payments to domestic banks may prefer to use ACH payments over wire transfers (albeit the ACH transfers usually taking more time to clear than wire transfers) when these entities are not in rush for such payments to be completed. However, technology that enables straight through processing from wire transfer to ACH transfers (e.g., direct fulfillment of wire transfers as ACH transfers) does not currently exist. Additionally, financial institutions (e.g., global financial institutions, FinTechs employing non-US payment settlement networks, or the like) may not always know the ACH routing details to deliver a payment via the ACH settlement network.

To address such long-felt but unsolved need of a technical platform (e.g., technical solution) for straight through processing from wire to ACH transfer, one or more embodiments herein disclose a smart routing process where electronic payment requests associated with wire transfers can reliably and accurately be processed straight through as an ACH transfer.

More specifically, in some embodiments, electronic payment requests may be filtered to identify those associated with wire transfers (e.g., MT103, MT102, pacs.008, SWIFT, or the like). The filtered electronic payment requests are converted from an original format into a native format associated with an entity (e.g., a specific financial institution such as a bank). This native format may be proprietary to the entity and/or be selected from an industry format (e.g., ISO MX). As discussed in more details below in reference to FIGS. 3-5C, the converted electronic payment request is then processed such that a first payment type (e.g., MT103, MT102, pacs.008, SWIFT, or the like) associated with the electronic payment request is transformed into a second payment type (e.g., ACH, or the like), and then subsequently fulfilled as the second payment type. By providing a smart routing process that addresses the unsolved need for an accurate and reliable way to conduct straight through processing from wire to ACH transfer, embodiments herein contribute directly as an improvement to the technical field of electronic payment technology.

The foregoing summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a device that may perform various operations in accordance with some example embodiments described herein.

FIG. 3 illustrates an example flowchart for performing smart routing of electronic payment requests, in accordance with some example embodiments described herein.

FIG. 4 illustrates an example flowchart for performing smart routing of electronic payment requests, in accordance with some example embodiments described herein.

FIG. 5A-5C illustrate an implementation example of the smart routing process, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), mainframe computers, industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

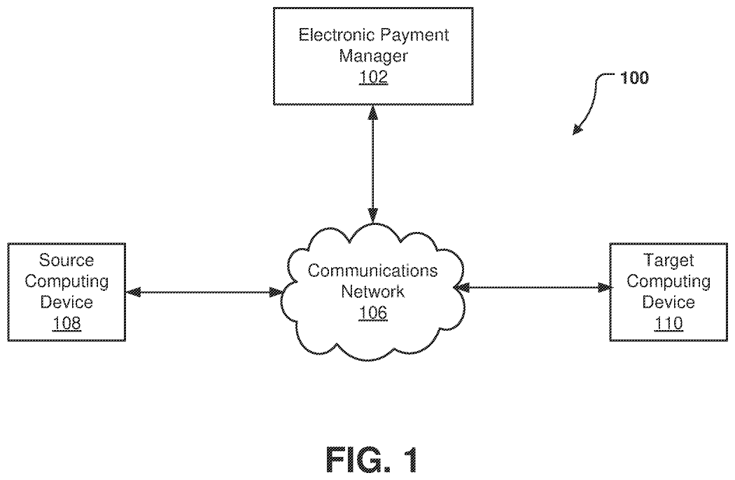

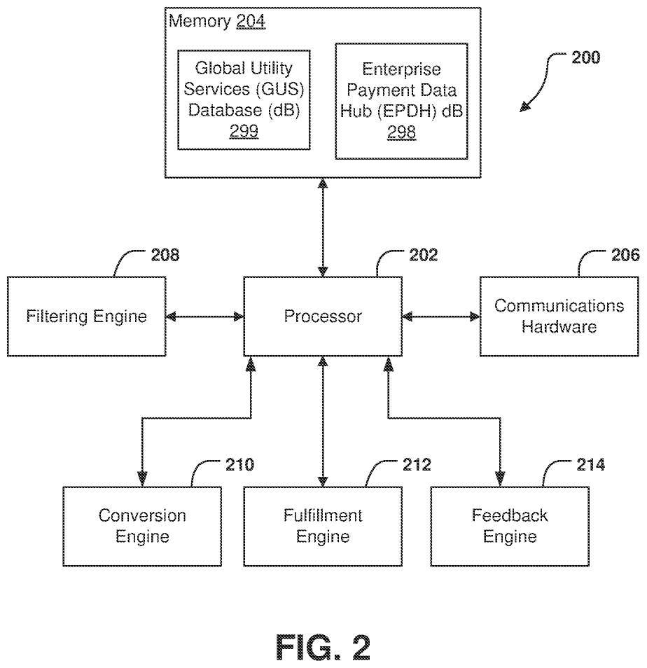

Example embodiments described herein may be implemented using any of a variety of computing devices or servers. To this end, FIG. 1 illustrates an example system 100 within which various embodiments may operate. As illustrated in FIG. 1, the system may include a electronic payment manager 102 that may receive and/or transmit information via communications network 106 (e.g., the Internet, SWIFT messaging networks, ACH or wires settlement networks, or the like) with any number of other devices, such as a source computing device 108 and a target computing device 110. In some embodiments, individuals may directly interact with the electronic payment manager 102 (e.g., via communications hardware 206 of electronic payment manager 102, which is discussed in more detail below in reference to FIG. 2), in which case a separate computing device connected to the electronic payment manager 102 (e.g., in an instance where the electronic payment manager 102 is a server disposed at a location that is not physically accessible to the individual) may not be utilized. Whether by way of direct interaction or via a separate computing device, an individual may communicate with, operate, control, modify, or otherwise interact with the electronic payment manager 102 to perform the various functions and achieve the various benefits described herein.

In some embodiments, electronic payment manager 102 may be implemented as one or more computing devices or servers, which may be composed of a series of components. Particular components of the electronic payment manager 102 are described in greater detail below with reference to apparatus 200 in FIG. 2.

In some embodiments, the source computing device 108 be embodied by any computing devices known in the art such as desktop or laptop computers, mobile phones (e.g., smart phones), tablets, servers, server devices, or the like. Although only a single source computing device 108 is shown in FIG. 1, some embodiments of the system 100 may include multiple source computing devices 108 (e.g., multiple source computing devices). In an instance where there are multiple source computing devices 108, each of the source computing devices need not themselves be independent devices, but may be peripheral devices communicatively coupled to other computing devices. In some embodiments, the source computing device 108 may be the source (e.g., the sender) of an electronic payment.

In some embodiments, the target computing device 110 may be embodied by any computing devices known in the art such as desktop or laptop computers, mobile phones (e.g., smart phones), tablets, servers, server devices, or the like. Although only a single target computing device 110 is shown in FIG. 1, some embodiments of the system 100 may include multiple target computing devices 110 (e.g., multiple target computing devices). In an instance where there are multiple target computing devices 110, each of the target computing devices need not themselves be independent devices, but may be peripheral devices communicatively coupled to other computing devices. In some embodiments, the target computing device 110 may be a recipient of an electronic payment.

### Example Implementing Apparatuses

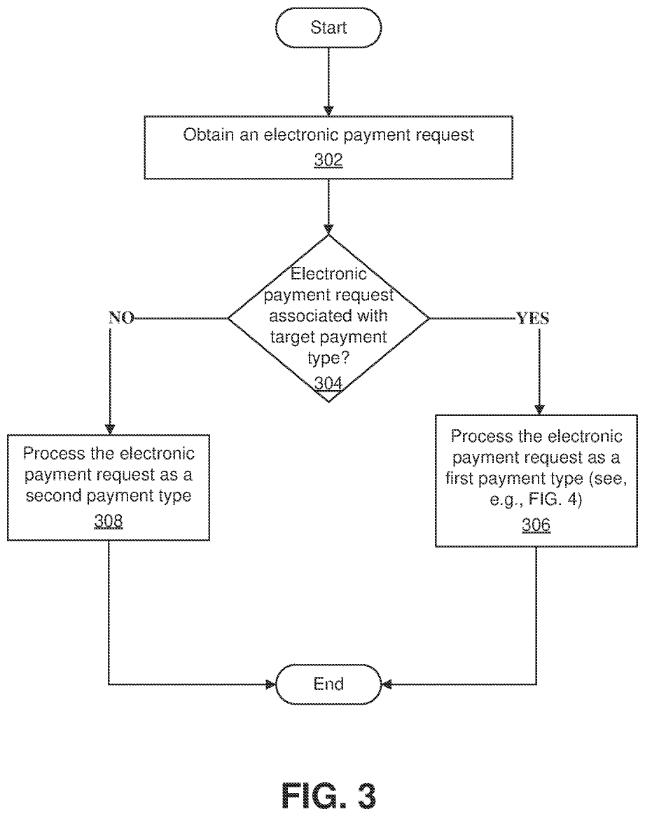

The electronic payment manager 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIG. 3. As illustrated in FIG. 2, the apparatus 200 may include processor 202, memory 204, communications hardware 206, a filtering engine 208, a conversion engine 210, a fulfillment engine 212 and a feedback engine 214, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

In some embodiments, memory 204 may be configured to store a global utility services (GUS) database (dB) 299 and an enterprise payment data hub (EPDH) dB 298. The GUS dB 299 may be configured to store reference data for an entity's (e.g., the entity receiving an electronic payment request via apparatus 200) various global payment applications. Such reference data may include, for example, a daily feed from the Federal Reserve with updates to American Banking Association (ABA) routing numbers (RTN) data (e.g., a catalog of ABA RTNs) and bank identifier codes (BICs) from existing and/or past SWIFT transactions. In some embodiments, EPDH dB 298 may be configured as a historical payment database that stores historical payment data associated with past electronic payment requests and/or processed electronic payments (e.g., electronic payments and payment requests associated with wire and ACH transfers or the like) received, initiated, and/or processed by the entity. For example, the EPDH dB may store reference data for one or more other entities (e.g., customers, other banks/financial institutions, customers of other banks/financial institutions, or the like) who have previously either sent or received payments to the entity's customers, including on-us transactions by the entity. More specifically, the EPDH dB may also store another catalog of ABA RTNs that are retrieved from the historical payment data. In some embodiments, having GUS and EPDH dBs configured with a large quantity of stored data (e.g., larger catalog(s) of ABA RTNs and larger amounts of historical payment data, for example, in the range of historical payment data covering over 800 million internal and external entities) advantageously improves the processing of wire transfers (namely, wire messages included in the wire transfers) as ACH transfers.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network (e.g., substantially similar or identical to the communications network 106 of FIG. 1). In some embodiments, the wired of wireless communication network may also include networks for instant payments and non-instant (ACH equivalent) payments in all countries. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

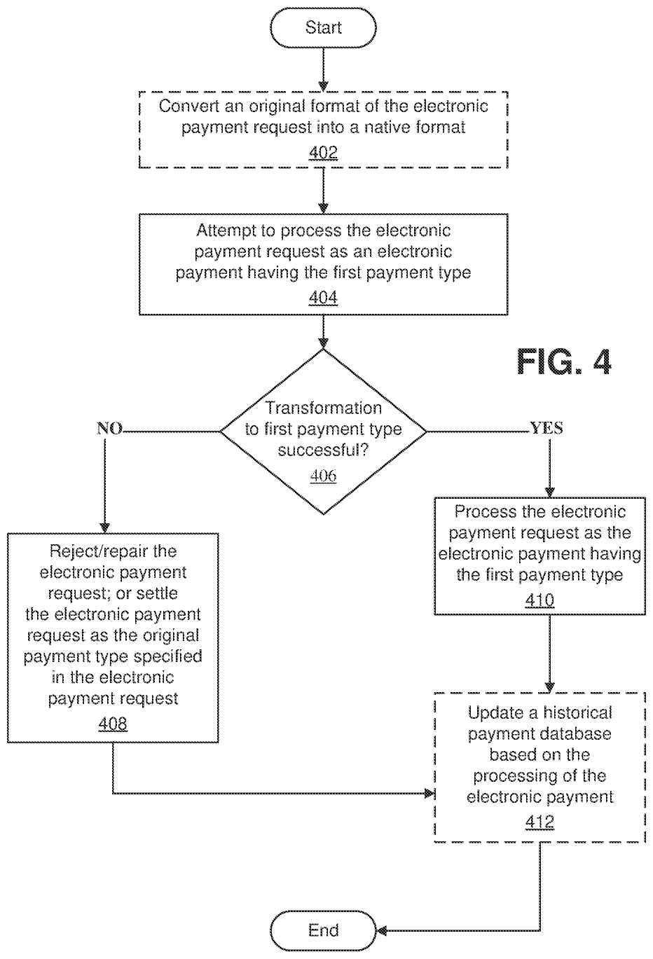

In addition, the apparatus 200 further comprises a filtering engine 208 that is configured to filter one or more electronic payment requests to identify one or more pre-selected payment types (which is discussed in more detail below with reference to FIGS. 3 and 4). The filtering engine 208 may utilize processor 202, memory 204, or any other hardware component included in the apparatus 200 to perform these operations, as described in connection with FIG. 3 below. The filtering engine 208 may further utilize communications hardware 206 to gather data from a variety of sources (e.g., any of the source computing device 108 and/or the target computing device 110, as shown in FIG. 1), and/or exchange data with an individual (e.g., a user, an administrator, a customer, or the like), and in some embodiments may utilize processor 202 and/or memory 204 to filter one or more electronic payment requests to identify one or more pre-selected payment types.

In addition, the apparatus 200 further comprises a conversion engine 210 that is configured to convert a payment type associated with an electronic payment request into a different payment type (which is discussed in more detail below with reference to FIGS. 3-5C). The conversion engine 210 may utilize processor 202, memory 204, or any other hardware component included in the apparatus 200 to perform these operations, as described in connection with FIG. 3 below. The conversion engine 210 may further utilize communications hardware 206 to gather data from a variety of sources (e.g., any of the source computing device 108 and/or the target computing device 110, as shown in FIG. 1), and/or exchange data with a user, and in some embodiments may utilize processor 202 and/or memory 204 to convert a payment type associated with an electronic payment request into a different payment type.

In addition, the apparatus 200 further comprises a fulfillment engine 212 that is configured to fulfill (e.g., complete or reject/repair) an electronic payment (which is discussed in more detail below with reference to FIGS. 3 and 4) associated with the electronic payment request. The fulfillment engine 212 may utilize processor 202, memory 204, or any other hardware component included in the apparatus 200 to perform these operations, as described in connection with FIG. 3 below. The fulfillment engine 212 may further utilize communications hardware 206 to gather data from a variety of sources (e.g., any of the source computing device 108 and/or the target computing device 110, as shown in FIG. 1), and/or exchange data with a user, and in some embodiments may utilize processor 202 and/or memory 204 to fulfill (e.g., complete or reject/repair) an electronic payment associated with the electronic payment request.

In addition, the apparatus 200 further comprises a feedback engine 214 that is configured to store and process feedback information (which is discussed in more detail below with reference to FIGS. 3 and 4). The feedback engine 214 may utilize processor 202, memory 204, or any other hardware component included in the apparatus 200 to perform these operations, as described in connection with FIG. 3 below. The feedback engine 214 may further utilize communications hardware 206 to gather data from a variety of sources (e.g., any of the source computing device 108 and/or the target computing device 110, as shown in FIG. 1), and/or exchange data with a user, and in some embodiments may utilize processor 202 and/or memory 204 to store and process feedback information.

Although components 202-214 are described in part using functional language, it will be understood that the particular implementations necessarily include the use of particular hardware. It should also be understood that certain of these components 202-214 may include similar or common hardware. For example, the filtering engine 208, conversion engine 210, fulfillment engine 212, and feedback engine 214 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the filtering engine 208, conversion engine 210, fulfillment engine 212, and feedback engine 214 may leverage processor 202, memory 204, or communications hardware 206 as described above, it will be understood that any of the filtering engine 208, conversion engine 210, fulfillment engine 212, and feedback engine 214 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the filtering engine 208, conversion engine 210, fulfillment engine 212, and feedback engine 214 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts.

### Example Operations

Turning to FIGS. 3 and 4, example flowcharts are illustrated that contain example operations implemented by example embodiments described herein. The operations illustrated in FIGS. 3 and 4 may, for example, be performed by the electronic payment manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, filtering engine 208, conversion engine 210, fulfillment engine 212, feedback engine 214, and/or any combination thereof. It will be understood that user interaction with the electronic payment manager 102 may occur directly via communications hardware 206, or may instead be facilitated by a separate computing device (not shown in the figures) that may have similar or equivalent physical componentry facilitating such user interaction.

Turning to FIG. 3, example operations are shown for performing smart routing of electronic payment requests.

As shown by operation 302, the apparatus 200 includes means, such as processor 202, memory 204, communications hardware 206, or the like, for obtaining an electronic payment request.

In some embodiments, the electronic payment request may be transmitted from an external source (e.g., the source computing device 108 of FIG. 1) and received by the communications hardware 206 of the apparatus. Each electronic payment request received by the apparatus 200 may be in any format (e.g., an original format used by a financial institution that transmitted the electronic payment request, a globally recognized format such as SWIFT, or the like) and may contain any combination of data (e.g., including information on the financial institution that transmitted the electronic payment request, information of the beneficiary of the payment, an amount of the payment, information related to the sender of the payment, or the like). A list of possible data (e.g., parameters/fields) to be included in each received electronic payment request is shown in Table 1 presented below in reference to the description of FIG. 3.

In some embodiments, there may be three banks involved in the electronic payment request including: (i) the origin bank (e.g., a bank associated with the source computing device 108 of FIG. 1), (ii) the bank operating the apparatus 200, and (iii) the beneficiary bank (e.g., a bank associated with the target computing device 110 of FIG. 1). In some embodiments, banks (ii) and (iii) may be the same bank. Alternatively, banks (ii) and (iii) may be different banks (or different regional subsidiaries of the same bank).

In some embodiments, the electronic payment request may be associated with any type of payment (e.g., an international wire transfer using wire transfer formats such as MT103/MT102/pacs.008 or the like, a domestic transfer using ACH, instant payments provided by The Clearinghouse, instant payments provided by FedNow, or the like) (herein referred to as “payment type”).

As shown in operation 304, the apparatus 200 includes means, such as processor 202, memory 204, communications hardware 206, filtering engine 208, or the like, for determining whether the electronic payment request (e.g., the electronic payment request received in operation 302) is associated with a pre-selected payment type.

In some embodiments, the filtering engine 208 may be configured (e.g., by an administrator and/or developer of the apparatus 200) to scan the electronic payment request (e.g., parse a content of the electronic payment request) to determine whether the electronic payment request is associated with a pre-selected payment type (e.g., the parameters/fields of the electronic payment request include values associated with the pre-selected payment type, the electronic payment request includes a message in a specialized/customizable field indicating that the electronic payment request should be treated as the pre-selected payment type, or the like). The pre-selected payment type may be any known payment type (e.g., ACH transfers, MT103/MT102/pacs.008 payment messages, SWIFT based payments, or the like) selected by a user (e.g., administrator) of the apparatus 200. Multiple pre-selected payment types may also be configured. Additionally or alternatively, in some embodiments, the filtering engine 208 may be configured to scan the electronic payment request to determine whether the electronic payment request includes explicit instructions and/or information identifying the electronic payment request as a candidate for conversion from wire to ACH transfer. For example, when a user (e.g., customer) of the financial institution that transmitted the initial electronic payment request is setting up the electronic payment request (e.g., via a website of the financial institution, with an employee such as a financial advisor, a clerk, or the like of the financial institution, or the like), the user may indicate that he or she is okay with (or prefers) the wire transfer taking longer to complete if the costs associated with conducting the wire transfer can be reduced. Such an indication by the user may be included in the electronic payment request and be identified by the filtering engine 208 during the scan of the electronic payment request as a trigger (e.g., independent of or in addition to the identification of the pre-selected payment type) for initiating a conversion of the electronic payment request from a wire transfer to an ACH transfer.

In some embodiments, instead of or in addition to parsing a content of the electronic payment request, the filtering engine 208 may determine the payment type through determining the type of payment channel or domain (e.g., an international wire transfer channel/domain, a domestic ACH transfer channel/domain, or the like) from which the electronic payment request was received.

For example, assume that a financial institution wishes to convert certain types of wire transfers into ACH transfers (namely, National Automated Clearing House Association (Nacha) Automated Clearing house (ACH) American Bankers Association (ABA) payments that use the above-discussed ABA RTNs). In this example, the financial institution may set the pre-selected payment types to specifically include MT103, MT102, and pacs.008 payment messages.

As shown in operation 306, the apparatus 200 includes means, such as processor 202, memory 204, communications hardware 206, filtering engine 208, conversion engine 210, fulfillment engine 212, feedback engine 214, or the like, for processing the electronic payment request (e.g., the electronic payment request received in operation 302) as an electronic payment of a first payment type in response to (e.g., the filtering engine 208) determining that the electronic payment request is associated with the pre-selected payment type (e.g., “YES” in operation 304).

In some embodiments, the first payment type may be any payment type set by a user (e.g., an administrator and/or developer of the apparatus 200). For example, continuing with the above example where a financial institution wishes to convert certain types of wire transfers into ACH transfers, the first payment type may be configured as “ACH transfers.”

Additional details as to how the electronic payment is processed as the first payment type is discussed below in reference to the operations of FIG. 4.

As shown in operation 308, the apparatus 200 includes means, such as processor 202, memory 204, communications hardware 206, filtering engine 208, fulfillment engine 212, or the like, for processing the electronic payment request (e.g., the electronic payment request received in operation 302) as an electronic payment of a second payment type different from the first payment type in response to (e.g., the filtering engine 208) determining that the electronic payment request is not associated with the pre-selected payment type (e.g., “NO” in operation 304).

In some embodiments, the second payment type may be identical to the payment type identified in the received electronic payment request. For example, if the electronic payment request obtained in operation 302 is an ACH transfer request, the second payment type would also be set as an ACH transfer. Said another way, as long as the electronic payment request is not determined to be associated with the pre-selected payment type, the electronic payment request is processed (e.g., settled and/or rejected by the fulfillment engine 212) as an electronic payment of its own original payment type using any known electronic payment processes associated with the original payment type of the electronic payment. In some embodiments, the received electronic payment request may also specify conditions regarding how the electronic payment request should be settled (e.g., the electronic payment request may specify a MT103 could be settled as TCH-RTP first, FedNow second, ACH third, and wire as a last resort). In such an example, the electronic payment request would not be settled as an ACH transfer until the first two conditions (e.g., settle first as TCH-RTP and second as FedNow) have failed.

Turning now to FIG. 4, example operations are shown for performing smart routing of electronic payments (namely, processing an electronic payment as the first payment type as shown in operation 306 of FIG. 3).

As shown in operation 402, the apparatus 200 includes means, such as processor 202, memory 204, communications hardware 206, conversion engine 210, or the like, for converting an original format of an electronic payment request (e.g., the electronic payment request obtained in operation 302 of FIG. 3) into a native format.

In some embodiments, the original format may be any payment message format used by an issuer (e.g., sender, source, or the like) of the electronic payment request. The native format may be a payment message format unique to the entity associated with (e.g., operating) the apparatus 200. In some embodiments, this step may be an optional step and the format of the obtained payment message need not be converted (e.g., the original format may be used as is without changes).

For example, continuing with the above example where a financial institution wishes to convert certain types of wire transfers into ACH transfers, the native format is a payment message format unique to and used by the financial institution that received the electronic payment request from another financial institution.

As shown in operation 404, the apparatus 200 includes means, such as processor 202, memory 204, communications hardware 206, conversion engine 210, or the like, for attempting to process the electronic payment request as an electronic payment having the first payment type (e.g., transforming an electronic payment associated with the electronic payment request from the pre-selected payment type into the first payment type).

In some embodiments, transforming the electronic payment associated with the electronic payment request from the pre-selected payment type to the first payment type may involve (e.g., comprise) identifying (e.g., by the conversion engine 210 and using a historical payment database (e.g., the EPDH dB 298 discussed above in FIG. 2)) a routing number associated with the first payment type using one or more parameters/fields included in the electronic payment request. Example parameters/fields are shown and described below in Table 1.

TABLE 1
Example Parameters/Fields included in Electronic Payment Requests

| Parameter/Field | Description |
|---|---|
| Bene Account Number | A bank account number of the beneficiary of the electronic payment. |
| Bene Name | Name of the beneficiary. |
| Bank Name | Name of the beneficiary's bank. |
| Bank Address | Address of the beneficiary's bank. |
| Bank SWIFT BIC | The business identifier code (BIC) (e.g., BIC 11) of the |
| | beneficiary's bank. |
| Bank Main/HQ | The primary ABA routing transit number of a bank. |
| NACHA ACH ABA | |
| Bank all other Active | A list of all other ABA routing transit numbers for a bank. |
| NACHA ACH ABA | |
| Bank CHIPS UID | A bank's Clearing House Interbank Payments System (CHIPS) |
| | Universal Identifier (UID). |
| Fedwire ABA wire | An ABA routing transit number for wire payments made on a |
| Routing Number | network operated by the Federal Reserves. |
| Bank IBAN | An international bank account number. |
| ABA RTN | The routing transit number required to deliver payments, whether |
| | ACH or wire payments. |
| Token Identifier (ID) | Personally identifiable information (e.g., email, phone, digital |
| for Beneficiary | account number, alias, etc.) of the beneficiary. |
| Check ABA | A routing transit number for issuing check payments. |
| Real-Time Payments | An indicator specifying whether an ABA RTN is eligible to receive |
| Enabled Routing | The Clearing House real time payments. |
| Indicator | |
| Wire Enabled Routing | An indicator specifying whether an ABA RTN is eligible to receive |
| Indicator | wires, whether via Fedwire or CHIPS. |

In some embodiments, the routing number associated with the first payment type may be stored in a lookup table included in the historical payment database. The lookup table may store, for example, the routing number as a value portion of one or more key-value-pairs where the key portion may be any (any one or multiple ones) of the parameters/fields included in the electronic payment request. Other formats for storing the routing number with one or more parameters/fields included in the electronic payment request may be used without departing from the scope of one or more embodiments disclosed herein.

For example, continuing with the above example where a financial institution wishes to convert certain types of wire transfers into ACH transfers, the conversion engine 210 may parse the parameters/fields included in the electronic payment request to determine a NACHA ACH ABA routing number. More specifically, the conversion engine 210 may reference a lookup table included in the EPDH dB 298 to determine whether one or more of the parameters/fields included in the electronic payment request is associated with a NACHA ACH ABA routing number for the beneficiary of the electronic payment associated with the electronic payment request. For example, in a first example scenario, the conversion engine 210 may search for an ABA routing number using a provided SWIFT BIC by relating/linking an account associated with the SWIFT BIC to a NACHA ACH ABA RTN. In a second example scenario, if a Main/HQ NACHA ACH ABA or wrong NACHA ACH ABA (but correct Bene Bank Name) and Bene Account is provided, then the conversion engine 210 will locate (e.g., the in the GUS dB and/or EPDH dB) the correct NACHA ACH ABA RTN by linking the account (e.g., account identified using the Bene Account and Bene Bank Name) to the correct NACHA ACH ABA RTN. In a third example scenario of one or more embodiments, if the Fedwire ABA wire Routing Number and Bene Account Number are provided, the conversion engine 210 will locate (e.g., in the GUS dB and/or EPDH dB) the correct NACHA ACH ABA RTN by matching the account (e.g., the account identified using the Fedwire ABA wire Routing Number and Bene Account Number) to the correct NACHA ACH ABA RTN.

In a fourth example scenario of one or more embodiments, if only the Bene Account Number and Bene Bank Name and the beneficiary's account does not exist in the bank's database (e.g., exist in GUS dB and/or EPDH dB), then the conversion engine 210 may locate the correct NACHA ACH ABA RTN using a customized logic used by the entity operating the apparatus 200. For example, the customized logic may be a state-based rule that depends on the account opening location or the subsidiary that first initiated a customer relationship with the beneficiary. More specifically, assume that a customer opened an account in California and the account in California is associated with a first NACHA ACH ABA RTN but that account opened in California is associated with a legacy account (e.g., in a different state such as Minnesota) with a different NACHA ACH ABA RTN, the conversion engine 210 may then use the NACHA ACH ABA RTN associated with the legacy account instead of the NACHA ACH ABA RTN associated with the newly opened account in California.

In yet another scenario of one or more embodiments, if only the beneficiary Token ID and Bank Name are provided, the conversion engine 210 may locate (e.g., in the GUS dB and/or EPDH dB) the correct NACHA ACH ABA RTN using an account (e.g., account identified using the beneficiary Token ID and Bank Name) if only a single account is identified. Other scenarios for retrieving a correct NACHA ACH ABA RTN may also exist based on the type of parameters/fields included in the received electronic payment request without departing from the scope of one or more embodiments disclosed herein.

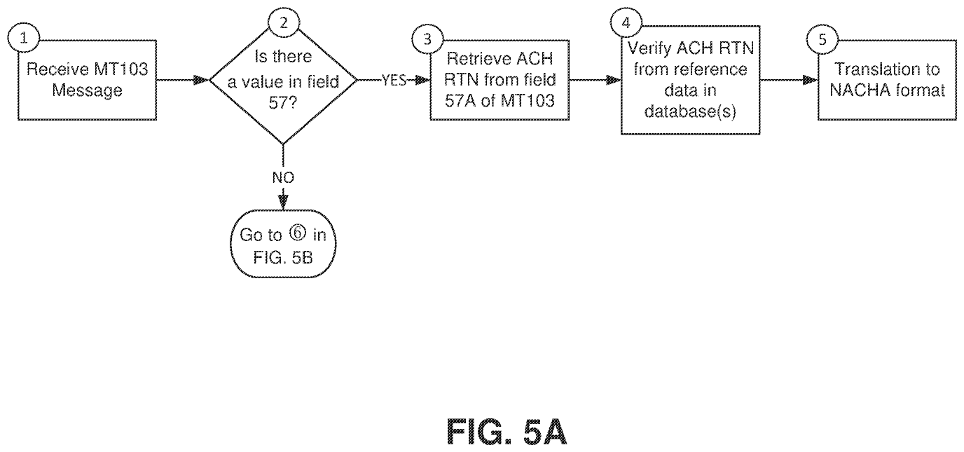

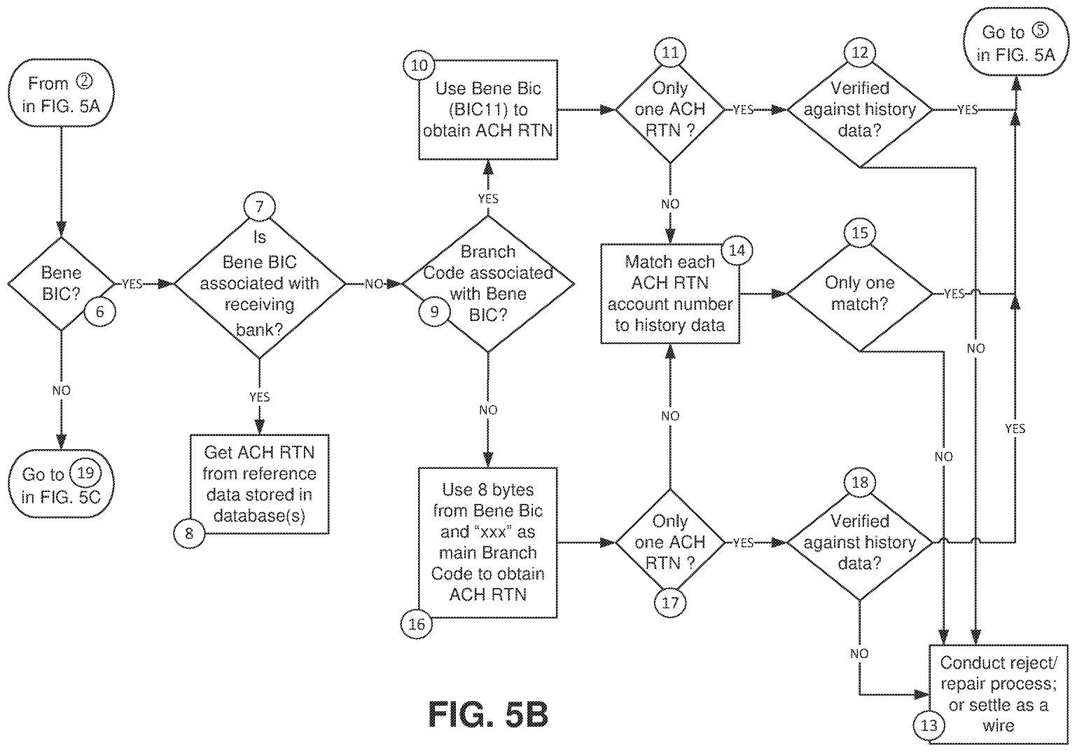

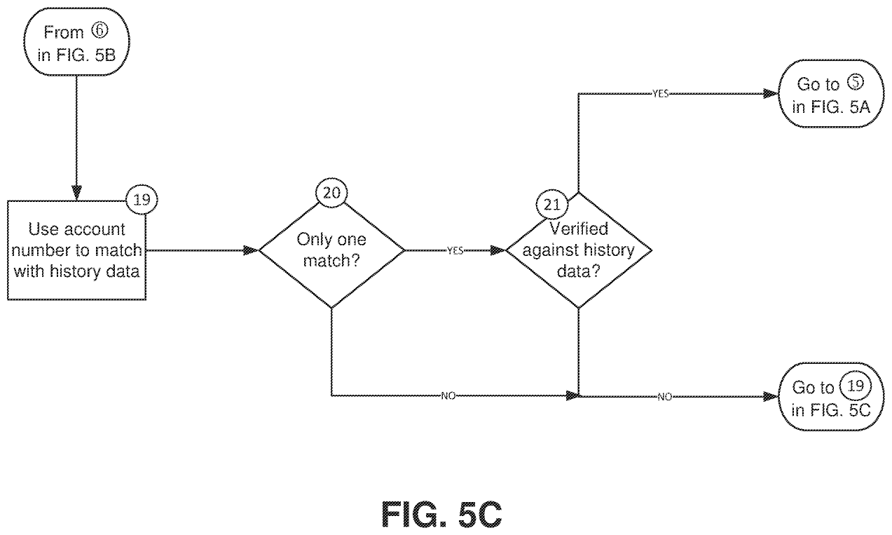

Detailed step-by-step transformation processes using one or more parameters/fields included in the electronic payment request are discussed below in reference to the implementation examples shown in FIGS. 5A-5C.

As shown in operation 406, the apparatus 200 includes means, such as processor 202, memory 204, communications hardware 206, conversion engine 210, or the like, for determining whether the transformation (e.g., the transformation in operation 404) is successful. If the transformation is determined to be successful (e.g., “YES” in operation 406), the process moves to operation 410. Alternatively, if the transformation is determined to be not successful (e.g., “NO” in operation 406), the process moves to operation 408.

In some embodiments, the transformation is deemed successful if the conversion engine 210 is able to conclusively (e.g., via an exact match) identify a routing number associated with the first payment type using one or more parameters/fields included in the electronic payment request. In some embodiments, an exact match may not be required as long as the identification by the conversion engine 210 exceeds a pre-determined confidence threshold (e.g., an example confidence threshold of 95%).

As shown in operation 408 (e.g., the operation following an unsuccessful transformation of the electronic payment from the pre-selected payment type to the first payment type), the apparatus 200 includes means, such as processor 202, memory 204, communications hardware 206, fulfillment engine 212, or the like, for rejecting and/or repairing the electronic payment (or, alternatively, settling the electronic payment request as the original payment type specified in the electronic payment request).

In some embodiments, rejecting the electronic payment may involve (e.g., by the fulfilment engine) transmitting the electronic payment request back to the originator (e.g., source computing device 108 shown in FIG. 1) along with a notification (e.g., a negative acknowledgement (NACK) message) indicating that the electronic payment request has failed (e.g., cannot be completed). Any other types of known electronic payment request rejection methods/processes may be used without departing from the scope of one or more embodiments disclosed herein.

In some embodiments, repairing the electronic payment request may involve (e.g., by the fulfilment engine using communications hardware 206) transmitting a message to the originator requesting additional information (e.g., additional information regarding one or more existing and/or missing parameters/fields in the electronic payment request, or the like). Any other types of known electronic payment request repairing methods/processes may also be used without departing from the scope of one or more embodiments disclosed herein.

Alternatively, in operation 408, instead of repairing the electronic payment request(s), all failed conversions from wire to ACH transfers may be processed as the original wire transfer (e.g., in the originally received wire transfer payment format of MT103/MT102/pacs.008 or the like). Said another way, electronic payment request(s) that fail to be converted may be processed to be settled as the original payment type specified in the received electronic payment request. Furthermore, information of such failed conversions from wire to ACH transfers (e.g., including the receipt of any NACHA reject codes such as R02, R03, R12, R13, or the like) may be transmitted to a learning loop configuration (discussed in more detail below in reference to operation 412 of FIG. 4) to be used as reference data for processing of future electronic payment requests (e.g., subsequently received ones of the electronic payment request).

In some embodiments, in operation 408, depending on whether the electronic payment request is rejected/repaired or processed as the original payment type, apparatus 200 may be configured to transmit (e.g., using communications hardware 206) positive or negative acknowledgements (e.g., in the form of ACK/NACK messages using formats such as SWIFT MT199/pacs.004 messages or the like) to the original sender of the electronic payment request (e.g., to source computing device 108 as shown in FIG. 1). More specifically, as discussed above, a NACK message may be sent when the electronic payment request is rejected because the conversion to ACH transfer has failed. Alternatively, in instances where the failed conversions from the original payment type to the first payment type (e.g., wire to ACH transfers) are processed as the original payment type (e.g., as wire transfers), the apparatus 200 may send an ACK message while also including additional information within the ACK message to notify the sender of the electronic payment request that the conversion has failed but the electronic payment request will still be processed as a wire. For example, the ACK message may include a statement such as a notification of change indicating that the electronic payment request is being reverted back to (e.g., being fulfilled as) the original payment format.

In some embodiments, when processing failed conversions from wire to ACH transfers as the original payment type (e.g., a wire transfer or the like), the apparatus 200 may use reverse translation logic to convert each ACH confirmation message back to standard practices used for wire transfers. In particular, the apparatus 200 may first obtain (e.g., using processor 202) one or more payment returns (e.g., ACH returns or the like) and/or one or more notification of change (NOC) files, the former of which (e.g., the payment returns) may indicate one or more failed conversions of the electronic payment request from the original payment type to the first payment type (e.g., from wire to ACH) while the latter of which (e.g., the NOC files) may not include any indications of failure (e.g., conversion failure, fulfilment failure, or the like). In some embodiments, the payment returns and NOC file(s) may be stored in memory 204 (e.g., in any of the GUS dB 299 or EPDH dB 298, or in a completely separate database configured within memory 204) and/or directly retrieved from the fulfillment engine 212. The apparatus 200 may then be configured to integrate information from the payment returns and the NOC file(s) to obtain traceability to the original electronic payment request in order to send one or more ACK/NACK messages regarding the settlement as the original payment type. For example, in some embodiments, the following scenarios and ACK/NACK messages may be observed: (i) if the conversion from the original payment type to the first payment type (e.g., wire to ACH) has failed (e.g., a payment return exists in the form of a return code per one or more NACHA Operating Rules or the like) and the electronic payment request is unable to settle as the original payment type, a conventional NACK message for the original payment type (e.g., a conventional NACK message for wire transfers) may be transmitted; (ii) if the conversion from the original payment type to the first payment type (e.g., wire to ACH) has failed but the electronic payment request is successfully settled as the original payment type (e.g., as the original wire transfer), an ACK message including a notification that the electronic payment request was settled as the original payment type (including details about the fees charged for the settlement of the electronic payment request as the original payment type) may be transmitted; (iii) if one or more NOCs file were obtained but the electronic payment request was still successfully settled as the first payment type (e.g., an ACH transfer), the NOC file(s) may be transmitted in a message formatted based on the original payment type (e.g., in the format for the original wire transfer); and (iv) if the electronic payment request successfully settled as the original payment type (e.g., there are no NOC file(s) or payment return(s) associated with the original electronic payment request), a positive ACK message in the format of the original payment type may be transmitted.

As shown in operation 410 (e.g., the operation following a successful transformation of the electronic payment from the pre-selected payment type to the first payment type), the apparatus 200 includes means, such as processor 202, memory 204, communications hardware 206, fulfillment engine 212, or the like, for processing the electronic payment request as the electronic payment having the first payment type.

In some embodiments, in an instance where the beneficiary specified in the electronic payment request is associated with the entity that received the electronic payment request in operation 302 of FIG. 3, processing the electronic payment as the first payment type may involve fulfilment of the payment amount specified (e.g., indicated) in the electronic payment request to an account of the beneficiary that is overseen by the entity.

Alternatively, in an instance where the beneficiary specified in the electronic payment request is associated with another entity that is different from the entity that received the electronic payment request in operation 302 of FIG. 3 (e.g., a different bank from the bank that received the electronic payment request), processing the electronic payment request as the first payment type may involve transmitting the electronic payment as the first payment type to the other entity to be processed by the other entity. Said another way, processing the electronic payment as the first payment type may involve fulfilment of the payment amount to the ultimate bank of the beneficiary.

As shown in operation 412, the apparatus 200 includes means, such as processor 202, memory 204, communications hardware 206, feedback engine 214, or the like, for updating a feedback database (which may be the (or a part of the) historical payment database) based on the processing of the electronic payment.

In some embodiments, after the electronic payment associated with the electronic payment request is processed as the first payment type (e.g., in Step 410), as the original payment type (e.g., Step 408), or if the electronic payment request is rejected and/or repaired (e.g., Step 408), the apparatus may receive (e.g., via communications hardware) feedback information regarding the processing of the electronic payment and/or the rejecting and/or repairing of the electronic payment request. The apparatus 200 may then store (e.g., via feedback engine 214) the feedback information in the feedback database such that the feedback information may be applied to (e.g., used in) subsequently received ones of the electronic payment request associated with the pre-selected payment type. This provides a learning loop configuration that advantageously improves the accuracy of the transformation process (e.g., transformation in operation 404) as subsequent electronic payment requests are received.

For example, continuing with the above example where a financial institution wishes to convert certain types of wire transfers into ACH transfers, assume that the electronic payment was forwarded to another bank to be processed as an ACH transfer. The processing at the other bank was successful but the other bank noticed that some parameters/fields in the electronic payment may be outdated. The other bank may provide feedback information including the updated parameters/fields to prevent/avoid the outdated information from causing a potential false negative (e.g., a false unsuccessful transformation) for subsequent electronic payment requests associated with the same beneficiary.

FIGS. 3 and 4 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Implementation Examples

FIG. 5A shows an implementation example of one or more embodiments disclosed herein (e.g., an implementation example of the transformation in operation 404 of FIG. 4). Further assume that each number surrounded in brackets below corresponds to the same number appearing in a circle in FIG. 5A (e.g., “[1]” shown below corresponds to \textcircled{1} shown in FIG. 5A). A discussion on the implementation example of FIG. 5A is as follows.

Initially, starting first with FIG. 5A, a wire transfer request (e.g., a SWIFT message) comes through as an MT103 message and the MT103 message is converted from an original format into native format [1]. The converted message is parsed to determine whether a value exists in data field 57 (e.g., standard SWIFT data fields indicating “account with institution” information such as data field 57A, data field 57C, or the like) [2]. If a value exists (e.g., “YES” at [2]) and the value is an ACH or Fedwire RTN included in data field 57C, the ACH or Fedwire RTN is retrieved [3]. The extracted ACH RTN is verified against reference data in the GUS dB 299 and/or EPDH dB 298 [4]. The wire transfer is then translated into a NACHA format (e.g., ACH transfer) using the verified ACH RTN [5].

Turning now to FIG. 5B, when a value does not exist in data field 57A (e.g., “NO” at [2]), a check is conducted to determine whether a beneficiary business identified code (BIC) is included in the wire transfer [6]. If a beneficiary BIC is included (e.g., “YES” at [6]) the system determines whether the bene BIC is a BIC associated with the bank that received the electronic payment request (e.g., whether the bank that received the electronic payment request holds the beneficiary account; this also determines whether the transaction can be settled by the bank (e.g., that the bank can deliver the payment to be beneficiary)) [7]. If the beneficiary BIC is associated with the bank that received the electronic payment request, the ACH RTN is retrieved from the GUS dB 299 and the wire transfer is translated into a NACHA format [8]. If the beneficiary BIC is not associated with the bank that received the electronic payment request, a determination is made as to whether the wire transfer includes a branch code that could be associated with a BIC (e.g., BIC11) [9]. If the wire transfer includes the branch code that could be associated with a BIC (e.g., “YES” at [9]), the BIC is used in conjunction with the GUS dB 299 and/or EPDH dB 298 to obtain one or more ACH RTNs [10]. At [11], a determination is then made as to whether only a single ACH RTN is retrieved at [10]. If only a single ACH RTN is retrieved (e.g., “YES” at [11]), the retrieved ACH RTN is compared to historical payment data in the EPDH dB 298 to determine using the historical data whether the ACH RTN is the correct one for the beneficiary [12]. If the ACH RTN is the correct one for the beneficiary (e.g., “YES” at [12]), the wire message is then translated into a NACHA format (e.g., ACH transfer) using the verified ACH RTN [5]. If the ACH RTN is the not the correct one for the beneficiary (e.g., “NO” at [12]), the wire message is sent to a reject/repair process or settled as a wire [13].

Additionally, if multiple ACH RTNs are retrieved (e.g., “NO” at [11]), the retrieved ACH RTNs are compared to historical payment data in the EPDH dB 298 to determine using the historical data whether there is a single ACH RTN among the ACH RTNs that is a unique match for the beneficiary of the wire transfer [12]. If there is only a single unique match among the ACH RTNs (e.g., “YES” at [12]), the wire message is then translated into a NACHA format (e.g., ACH transfer) using the verified ACH RTN [5]. If there is no single unique match among the ACH RTNs (e.g., “NO” at [12]), the wire message is sent to a reject/repair process or settled as a wire [13].

Going back to [9], if there is no branch code included in the wire transfer (e.g., “NO” at [9]), an 8-byte beneficiary BIC and a place holder “XXX” main Branch Code is used as the BIC to determine (using the EPDH dB 298) to obtain one or more ACH RTNs. A determination is then made as to whether there is a single ACH RTN among the ACH RTNs that is a unique match for the beneficiary of the wire transfer [17]. If the determination at is NO, the process goes to [14]. If the determination at is YES, the retrieved ACH RTN is compared to historical payment data in the EPDH dB 298 to determine using the historical data whether the ACH RTN is the correct one for the beneficiary of the wire transfer [18]. If the ACH RTN is the correct one for the beneficiary of the wire transfer (e.g., “YES” at [18]), the wire message is then translated into a NACHA format (e.g., ACH transfer) using the verified ACH RTN [5]. If the ACH RTN is the not the correct one for the beneficiary of the wire transfer (e.g., “NO” at [18]), the wire message is sent to a reject/repair process or settled as a wire [13].

Finally, going back to determination at [6], if a beneficiary BIC is not included in the wire transfer (e.g., “NO” at [6]), an account number included in the wire transfer is used to match with one or more beneficiary information stored in the historic payment database, as shown in FIG. 5C [19]. A determination is then made as to whether only a single unique match is made using the account number (e.g., matching the account number to a single unique ACH RTN) [20]. If there is only a single unique match using the account number (e.g., “YES” at [20]), the matched ACH RTN is verified using the EPDH dB 298 and/or the GUS dB 299 [21]. If there are no single unique match (e.g., the account number matches to multiple ACH RTNs) (e.g., “NO” at [20]), the wire transfer is sent to a reject/repair process [13]. If the matched ACH RTN can be verified using the EPDH dB 298 and/or the GUS dB 299 (e.g., “YES” at [21]), the wire message is then translated into a NACHA format (e.g., ACH transfer) using the verified ACH RTN [5]. If the matched ACH RTN cannot be verified using the EPDH dB 298 and/or the GUS dB 299 (e.g., “NO” at [21]), the wire message is sent to a reject/repair process or settled as a wire [13].

### CONCLUSION

As described above, example embodiments provide methods and apparatuses that enable smart routing of electronic payment requests. For example, in some embodiments, electronic payment requests are filtered to identify those associated with wire transfers (e.g., MT103, MT102, pacs.008, SWIFT, or the like). The filtered electronic payment requests are converted from an original format into a native format associated with an entity (e.g., a specific financial institution such as a bank). As discussed in more details below in reference to FIGS. 3-5C, the converted electronic payment requests are then processed such that a first payment type (e.g., MT103, MT102, pacs.008, SWIFT, or the like) associated with the electronic payment request is transformed (e.g., fulfilled as) into a second payment type (e.g., ACH, or the like), and then subsequently fulfilled as the second payment type. By providing a smart routing process that addresses the unsolved need for an accurate and reliable way to conduct straight through processing from wire to ACH transfer, embodiments herein contribute directly as an improvement to the technical field of electronic payment technology.

As these examples all illustrate, example embodiments contemplated herein provide technical solutions that solve real-world problems faced during normal day-to-day providing of electronic payment services by one or more entities (e.g., financial institutions). Because the current trend in technology does not allow for the conversion of wire to ACH transfers, the inventors have found the importance of providing such a solution to, for example, provide cheaper alternatives for international entities (or international subsidiaries of domestic entities) that frequently wire payments to domestic banks may prefer to use ACH payments over wire transfers (albeit the ACH transfers usually taking more time to clear than wire transfers) when these entities are not in rush for such payments to be completed. As a result, one or more embodiments disclosed herein not only provide a direct improvement to the technical field of electronic payment technology but also resolves a long-felt but unsolved need by consumers (e.g., customers) of such entities that provide electronic payment services.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
obtaining, by communications hardware of an electronic payment manager, an electronic payment request;
determining, by a filtering engine of the electronic payment manager, that the electronic payment request is associated with a pre-selected payment type; and
processing, in response to the determination and by a conversion engine of the electronic payment manager, the electronic payment request as an electronic payment having a first payment type different from the pre-selected payment type.

2. The method of claim 1, wherein processing the electronic payment request as the electronic payment having the first payment type further comprises:
initiating transformation, by the conversion engine and using the electronic payment request, of the pre-selected payment type into the first payment type;
determining, by the conversion engine, that the transformation is successful; and
processing, in response to determining that the transformation is successful and by a fulfillment engine of the electronic payment manager, the electronic payment request as the electronic payment having the first payment type.

3. The method of claim 2, wherein the pre-selected payment type is a wire transfer payment type and the first payment type is a National Automated Clearing House Association (NACHA) Automated Clearing house (ACH) American Bankers Association (ABA) payment type.

4. The method of claim 3, wherein initiating transformation of the pre-selected payment type into the first payment type further comprises:
identifying, by the conversion engine and using a historical payment database storing a catalog of NACHA ACH ABA routing numbers, a NACHA ACH ABA routing number using one or more parameters included in the electronic payment, wherein the NACHA ACH ABA routing number is one of the NACHA ACH ABA routing numbers in the catalog.

5. The method of claim 4, wherein the one or more parameters comprise at least one of a business identifier code (BIC) number, a beneficiary name, a beneficiary account number, a beneficiary bank name, or NACHA ACH ABA information.

6. The method of claim 2, wherein processing the electronic payment request as the electronic payment having the first payment type further comprises:
converting, by the conversion engine and before the transformation, the electronic payment request from an original format to a native format.

7. The method of claim 2, wherein the method further comprises:
receiving, via the communications hardware and after the processing of the electronic payment request as the electronic payment having the first payment type, feedback information regarding the processing of the electronic payment having the first payment type; and
storing, by a feedback engine of the electronic payment manager, the feedback information in a feedback database,
wherein the feedback information is applied, by the conversion engine, to subsequently received ones of the electronic payment request having the pre-selected payment type.

8. An apparatus comprising:
communications hardware configured to obtain an electronic payment request;
a filtering engine configured to determine that the electronic payment request is associated with a pre-selected payment type; and
a conversion engine configured to process, in response to the determination by the filtering engine, the electronic payment request as an electronic payment having a first payment type different from the pre-selected payment type.

9. The apparatus of claim 8, wherein processing the electronic payment request as the electronic payment having the first payment type further comprises, by the conversion engine:
initiating transformation, using the electronic payment request, of the pre-selected payment type into the first payment type; and
determining that the transformation is successful,
wherein the apparatus further comprises a fulfillment engine configured to process, in response to the conversion engine determining that the transformation is successful, the electronic payment request as the electronic payment having the first payment type.

10. The apparatus of claim 9, wherein the pre-selected payment type is a wire transfer payment type and the first payment type is a National Automated Clearing House Association (NACHA) Automated Clearing House (ACH) American Bankers Association (ABA) payment type.

11. The apparatus of claim 10, wherein initiating transformation of the pre-selected payment type into the first payment type further comprises, by the conversion engine:
identify, and using a historical payment database storing a catalog of NACHA ACH ABA routing numbers, a NACHA ACH ABA routing number using one or more parameters included in the electronic payment, wherein the NACHA ACH ABA routing number is one of the NACHA ACH ABA routing numbers in the catalog.

12. The apparatus of claim 11, wherein the one or more parameters comprise at least one of a business identifier code (BIC) number, a beneficiary name, a beneficiary account number, a beneficiary bank name, or NACHA ACH ABA information.

13. The apparatus of claim 9, wherein processing the electronic payment request as the electronic payment having the first payment type further comprises, by the conversion engine:
converting, before the transformation, the electronic payment request from an original format to a native format.

14. The apparatus of claim 9, wherein:
the communications hardware is further configured to receive, after the processing of the electronic payment request as the electronic payment having the first payment type by the fulfillment engine, feedback information regarding the processing of the electronic payment having the first payment type,
the apparatus further comprises a feedback engine that is configured to store the feedback information in a feedback database, and
the conversion engine is further configured to apply the feedback information to subsequently received ones of the electronic payment request having the pre-selected payment type.

15. A computer program product comprising at least one non-transitory computer-readable storage medium storing software instructions that, when executed, cause an apparatus to:
obtain an electronic payment request;
determine that the electronic payment request is associated with a pre-selected payment type; and
process, in response to the determination, the electronic payment request as an electronic payment having a first payment type different from the pre-selected payment type.

16. The computer program product of claim 15, wherein processing the electronic payment request as the electronic payment having the first payment type further comprises:
initiating transformation, using the electronic payment request, of the pre-selected payment type into the first payment type;
determining that the transformation is successful; and
processing, in response to determining that the transformation is successful, the electronic payment request as the electronic payment having the first payment type.

17. The computer program product of claim 16, wherein the pre-selected payment type is a wire transfer payment type and the first payment type is a National Automated Clearing House Association (NACHA) Automated Clearing House (ACH) American Bankers Association (ABA) payment type.

18. The computer program product of claim 17, wherein initiating transforming of the pre-selected payment type into the first payment type further comprises:
identifying, using a historical payment database storing a catalog of NACHA ACH ABA routing numbers, a NACHA ACH ABA routing number using one or more parameters included in the electronic payment, wherein the NACHA ACH ABA routing number is one of the NACHA ACH ABA routing numbers in the catalog.

19. The computer program product of claim 18, wherein the one or more parameters comprise at least one of a business identifier code (BIC) number, a beneficiary name, a beneficiary account number, a beneficiary bank name, or NACHA ACH ABA information.

20. The computer program product of claim 16, wherein processing the electronic payment request as the electronic payment having the first payment type further comprises:
converting, before the transformation, the electronic payment request from an original format to a native format.
